(19) United States
(12) Patent Application Publication
(10) Pub. No.: US 2019/0080371 A1
(43) Pub. Date: Mar. 14, 2019

(54) REAL ESTATE BUYER NARRATIVE FEEDBACK APPLICATION

(71) Applicant: Carrier Corporation, Palm Beach Gardens, FL (US)

(72) Inventor: Tony Spath, West Hartford, CT (US)

(73) Assignee: Carrier Corporation, Palm Beach Gardens, FL (US)

(21) Appl. No.: 16/121,923

(22) Filed: Sep. 5, 2018

Related U.S. Application Data
(60) Provisional application No. 62/557,251, filed on Sep. 12, 2017.

(51) Int. Cl. G06Q 30/02; G06Q 10/06; G10L 15/26; G06F 17/27; G06Q 50/16

(52) U.S. Cl. CPC G06Q 30/0282; G06Q 10/06393; G06Q 50/163; G06F 17/2785; G06F 17/277; G10L 15/26

(57) ABSTRACT

A method for providing feedback of a buyer regarding a real estate property visited by the buyer including recording narrative feedback data of the buyer during a property showing of a subject real estate property; and associating the narrative feedback data for the subject real estate property to a value.

### CROSS-REFERENCE TO RELATED APPLICATIONS

This application claims the benefit of provisional application Ser. No. 62/557,251, filed Sep. 12, 2017.

### BACKGROUND

The present disclosure relates generally to a real estate buyer feedback system, and more particularly, to a system and method to quantify verbal feedback during a property showing.

In the real estate industry, the listing agent must often, at the seller's behest, contact the showing agent to receive feedback as to the buyer's perspective on the home. This can be a time-consuming practice and can lead to seller frustration in understanding what actions may facilitate sale of their home from the perspective of the buyer who viewed their home.

### SUMMARY

A method for processing feedback for a real estate property according to one disclosed non-limiting embodiment of the present disclosure can include receiving narrative feedback data for a subject real estate property and converting the narrative feedback data for the subject real estate property to a value in response to at least one location word and at least one clarifying word proximate to the location word.

A further embodiment of the present disclosure may include that the receiving the narrative feedback data is performed with a microphone of a handheld device.

A further embodiment of the present disclosure may include that the converting the narrative feedback data for the subject real estate property is performed with a subsystem with which a real estate feedback application on a handheld device is in communication.

A further embodiment of the present disclosure may include that the converting the narrative feedback data for the subject real estate property is individually performed for each of a multiple of locations in the subject real estate property via a database that stores a multiple of the clarifying words and an associated value of each of the multiple of clarifying words.

A further embodiment of the present disclosure may include averaging the value for each of the multiple of locations to determine a total score for the subject real estate property.

A further embodiment of the present disclosure may include weighting the value for each of the multiple of locations of the subject real estate property.

A further embodiment of the present disclosure may include weighting the value for at least one of the multiple of locations of the subject real estate property to determine a total score for the subject real estate property.

A further embodiment of the present disclosure may include weighting the value for at least one of the multiple of locations of the subject real estate property in response to a user input to a handheld device operating a real estate feedback application.

A further embodiment of the present disclosure may include that the receiving the narrative feedback data is performed with a text input to a handheld device operating a real estate feedback application.

A further embodiment of the present disclosure may include that the converting the narrative feedback data comprises scanning the narrative feedback data for the at least one location word from a database via a semantic engine.

A further embodiment of the present disclosure may include that the converting the narrative feedback data comprises scanning the narrative feedback data for the at least one clarifying word from the database via the semantic engine.

A further embodiment of the present disclosure may include that the converting the narrative feedback data comprises associating the clarifying word with the location word based on a predetermined distance.

A further embodiment of the present disclosure may include that the predetermined distance is a predetermined number of words.

A further embodiment of the present disclosure may include that the converting the narrative feedback data comprises associating the clarifying word with a ranking value in a database from external a handheld device prior to the converting, the handheld device accessing the ranking value during the converting.

A further embodiment of the present disclosure may include that the ranking value is a numerical value.

A further embodiment of the present disclosure may include that the ranking value is associated with a Likert scale.

A real estate narrative feedback application according to one disclosed non-limiting embodiment of the present disclosure can include a speech to text engine to receive narrative feedback data for a subject real estate property; a database of a multiple of clarifying words and an associated value of each of the multiple of clarifying words; and a semantic engine in communication with the speech to text engine and the database to convert the narrative feedback data into a value for the subject real estate property.

A further embodiment of the present disclosure may include that at least one of the speech to text engine, the database, and the semantic engine, run on a handheld device.

A further embodiment of the present disclosure may include determining a total score for the subject real estate property.

A further embodiment of the present disclosure may include that the associated value of each of the multiple of clarifying words is associated with a Likert scale.

The foregoing features and elements may be combined in various combinations without exclusivity, unless expressly indicated otherwise. These features and elements as well as the operation thereof will become more apparent in light of the following description and the accompanying drawings. It should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic system diagram of a real estate feedback application system.

FIG. 2 is a schematic diagram of a handheld device.

FIG. 3 is a flowchart of a method to provide feedback for real estate, with the system of FIG. 1.

FIG. 4 is a screenshot of the real estate feedback application property listing view.

FIG. 5 is a screenshot of the real estate feedback application feedback view.

FIG. 6 is a schematic diagram of a system to provide feedback for real estate which is a portion of the system of FIG. 1.

FIG. 7 is a flowchart to provide feedback from a buyer's handheld device.

FIG. 8 is a schematic block diagram of feedback provided from a buyer's handheld device to a seller.

FIG. 9 is a general schematic diagram of a narrative feedback system according to one embodiment.

FIG. 10 is a schematic diagram of an architecture for a verbal real estate feedback application of the narrative feedback system.

FIG. 11 is a chart of clarifying words for the verbal real estate feedback application.

FIG. 12 is a schematic block diagram illustrating operation of the verbal real estate feedback application.

FIG. 13 is a schematic block diagram to quantify verbal feedback by the verbal real estate feedback application.

FIG. 14 is a chart illustrating scoring of the verbal feedback.

### DETAILED DESCRIPTION

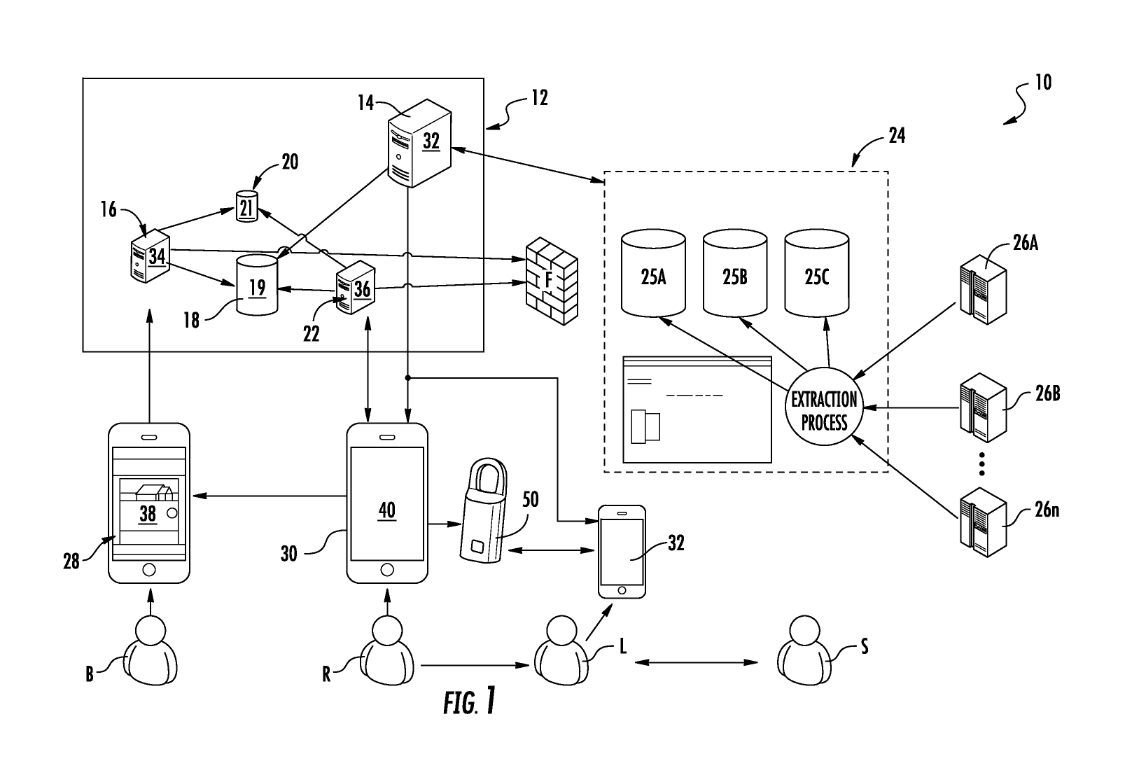

FIG. 1 schematically illustrates a system 10 to facilitate communication for real estate transactions. A prospective property buyer “B” is typically represented by a showing agent “R” while a property seller “S” is typically represented by a listing agent “L.” The listing agent “L” typically communicates with the buyer “B” only indirectly, such as by communication with the showing agent “R,” who then communicates information with the buyer “B.” Although only particular agents are referred to in the illustrated embodiments, the functions of such personnel may be otherwise assigned or rearranged. For example, the listing agent “L” may be a senior person in an agency who utilize a seller's assistant. The showing agent “R” may similarly utilize a showing assistant.

The system 10 generally includes a subsystem 12 that may be controlled by a single owner. The subsystem 12 generally includes one or more of a listing recommendation server 14, a buyer server 16, a buyer storage system 18, a log storage system 20, and an electronic key server 22. The listing recommendation server 14 communicates with the buyer storage system 18, the log storage system 20, and a storage system 24. The buyer storage system 18 includes a database 19 that stores, for example, feedback created by the buyer “B” (e.g., buyer feedback, third party feedback, etc.). The log storage system 20 includes a database 21 that collects activity data associated with the property showings.

The storage system 24 may include, but not be limited to, a database for managing key holders 25A, a security database 25B that hosts security protocols, and a listing database 25C that stores extracted property data from external databases 26A, 26B, 26N. The storage system 24 communicates with the external databases 26A-26N such as the Real Estate Transaction Standard (RETS) framework that stores MLS data. Communication between the various servers may include internet protocols or the like. The MLS data may include information such as number of bedrooms, number of bathrooms, price of listing, etc. RETS is a framework that can be adopted by computer systems to receive data from the Multiple Listing Service (MLS) servers, as well as those of other real estate systems provided they also have software installed designed to communicate using the RETS framework. The national association of realtors refers to RETS as a “common language.”

A multiple of handheld devices 28, 30, 32, may communicate with the subsystem 12. For example, the handheld devices 28, 30, 32, may be a smartphone, tablet, or other handheld device of the respective individual. Handheld device 28 is used by the potential buyer “B,” handheld device 30 is used by the showing agent “R,” and handheld device 32 is used by the listing agent “L. Various other handheld devices such as those used by the third parties “T” may also be in communication with the subsystem 12 either directly or through communication with the handheld devices 28, 30, 32, as an intermediary.

Information is accessible by the listing agent “L” through the subsystem 12 so that the listing agent “L” can, for example, generate reports for their seller “S,” send updates about a particular listing to showing agents “R”, or provide feedback from a buyer “B” to their seller “S.” The subsystem 12 may also obtain information from a Real Estate Transaction Standard (RETS) framework that stores MLS data. The subsystem 12 may also obtain information generated by an electronic key box 50 that occurs as a consequence of the showing, such as number of times shown, time spent at the subject property for each showing, return showings, etc. The subsystem 12 may also be used by the listing agents “L” to receive automatic notification (e.g., email notices) when a showing occurs at their listings. The subsystem 12 may also be used by the buyer “B” as a repository for information (e.g., details of each property the buyer has viewed, feedback on the properties, etc.). The seller “S” can also receive feedback from the buyer “B” either directly from the subsystem 12, or through communications with the listing agent “L” who communicates with the subsystem 12.

The listing recommendation server 14 hosts, for example, at least an analytics software application 32 that compiles and runs analytics against buyer ratings and MLS listing data from the storage system 24. The buyer server 16 hosts a buyer application program interface (API) 34, and the electronic key server 22 hosts an electronic key API 36. An application program interface (API) may include a set of routines, protocols, and/or tools for building software applications. The API specifies how software components should interact. APIs are used when programming graphical user interface (GUI) components. A server-side web API is a programmatic interface with one or more publicly exposed endpoints to a defined request-response message system.

The listing recommendation server 14 may communicate with a real estate application 38 on the handheld device 28 through the buyer API 34. An agent application 40 on the handheld device 30 may communicate with the listing recommendation server 14 and the electronic key server 22. The buyer API 34 and the electronic key API 36 may also communicate with other external systems through a firewall “F.”

The real estate application 38 may be a mobile application on the handheld device 28 that may be used by the buyer “B” to rate the properties they have seen and, as will be further described below, receive third party feedback from third parties “T” based on the buyer “B” feedback. The real estate application 38 communicates with the buyer storage system 18 through the buyer API 34 which then stores the feedback, ratings, and notes taken by the property buyer in the database 19 of the buyer storage system 18.

The agent application 40 may be a mobile application on the handheld device 30 that may be used by the showing agent “R” to access the electronic key boxes 50 via a short distance communication standard (e.g., Bluetooth). Alternatively, or in addition, the electronic key boxes 50 may be connected (e.g., cellular) directly to the listing recommendation server 14. The electronic key API 36 of the electronic key server 22 communicates with the agent application 40 to sync activity information from the electronic key boxes 50 to the electronic key API 36 (e.g., accessed key boxes, update the count of proprietary keys generated for that particular property, create a timestamp indicating that lockbox is opened), and showing notifications (e.g., to an associated showing agent “R”).

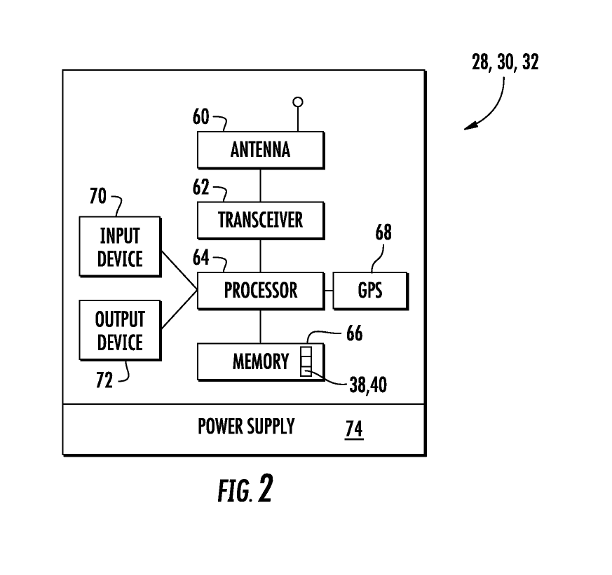

With reference to FIG. 2, each handheld device 28, 30, 32, generally includes a handheld device antenna 60, a handheld device transceiver 62, a handheld device processor 64, a handheld device memory 66, a GPS module 68, an input device 70, a display 72, and a handheld device power supply 74. The handheld device processor 64 may be any type of microprocessor having desired performance characteristics. The handheld device memory 66 may include any type of computer readable medium that stores the data and executable instructions described herein below. The executable instructions may be stored or organized in any manner and at any level of abstraction, such as in connection with one or more applications, processes, routines, procedures, methods, etc. The handheld device transceiver 62 is a transceiver of a type corresponding to the transceiver 62 and the handheld device antenna 60 is a corresponding antenna.

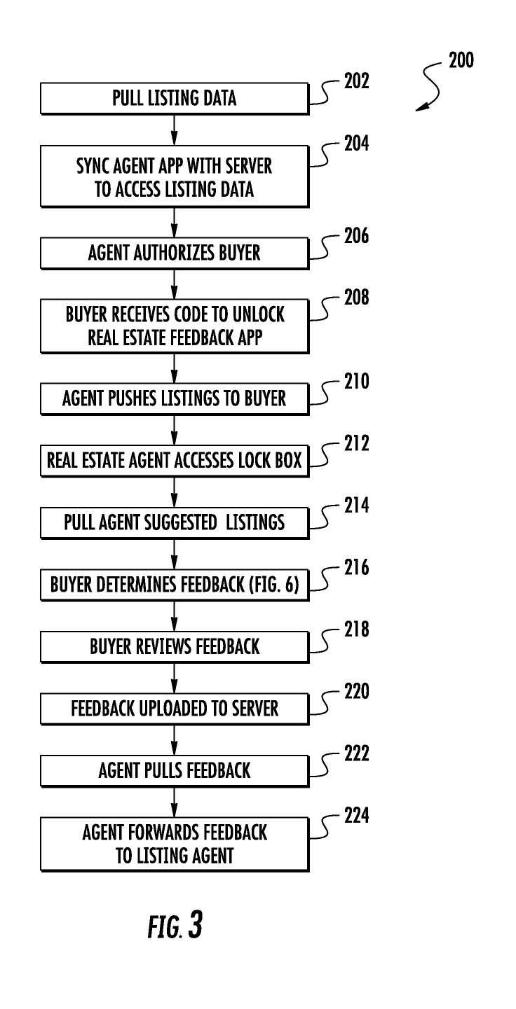

With reference to FIG. 3, a method 200 for operation of the system 10 is disclosed in terms of functional block diagrams. The functions are programmed software routines capable of execution in various microprocessor based electronics control embodiments and represented herein as block diagrams.

Initially, the owner of the subsystem 12 may have agreements with MLS to selectively extract (202) data such as MLS data from the external data servers 26A-26N (FIG. 1) through the listing recommendation server 14. Next, the agent application 40 syncs (204) with the listing recommendation server 14 and pulls MLS data for desired property listings of interest to the buyer “B” as, for example, selected by the showing agent “R.” This may be performed through an automated sync through the agent application 40. The showing agent “R” may also perform a manual sync to obtain the MLS data.

Through the agent application 40, the showing agent “R” can then authorize (206) the property buyer “B” to access the desired property listings of interest to the buyer “B.” Through the agent application 40, the showing agent “R” may, for example, authorizes the buyer “B” through input of buyer identification information (e.g., buyer name and email address.) The buyer identification information is then communicated to the listing recommendation server 14 so that the listing recommendation server 14 communicates the buyer “B” (e.g., via email to provide a link to an app store) with a code to unlock (208) the real estate application 38. The buyer “B” is then authorized to download the real estate application 38 and the desired property listings of interest to the buyer “B,” to maintain the value of the showing agent “R” in the real estate transaction. Alternatively, the buyer “B” already has the real estate application 38 and the desired property listings of interest to the buyer “B” are readily received.

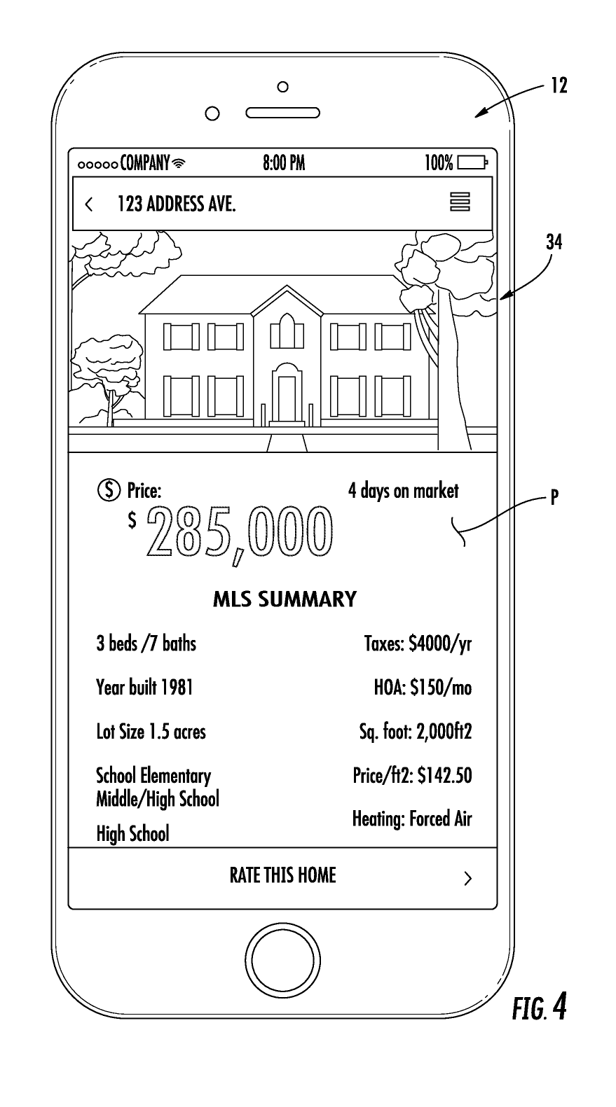

Through the agent application 40, the showing agent “R” can continue to push (210) property listings to the real estate application 38. Access may be provided for one or more properties by a showing code, or other information that unlocks one or more modules in the real estate application 38. The modules may include features or other aspects that are particular tailored to certain parties in the real estate transaction. The showing agent “R” is able to selectively push the desired property listings of interest to the buyer “B” (one example property listing illustrated by screenshot “P”; FIG. 4) through the subsystem 12 to be viewable within the real estate application 38. The showing agent “R” also uses the agent application 40 to operate the electronic key box 50 to access the property for showing to the buyer “B.”

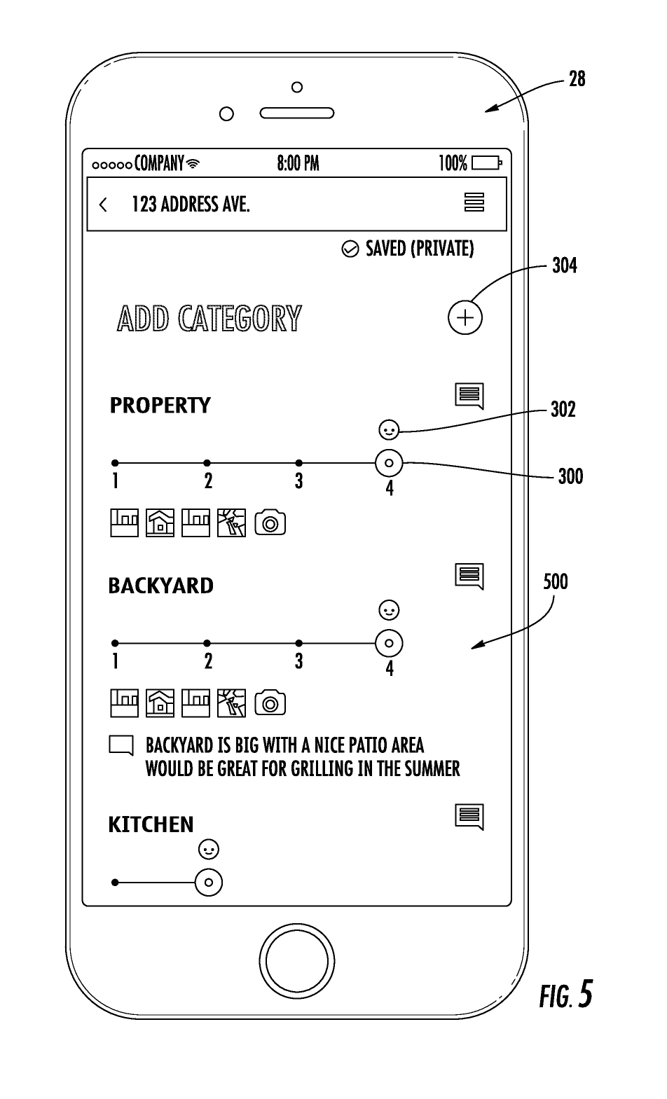

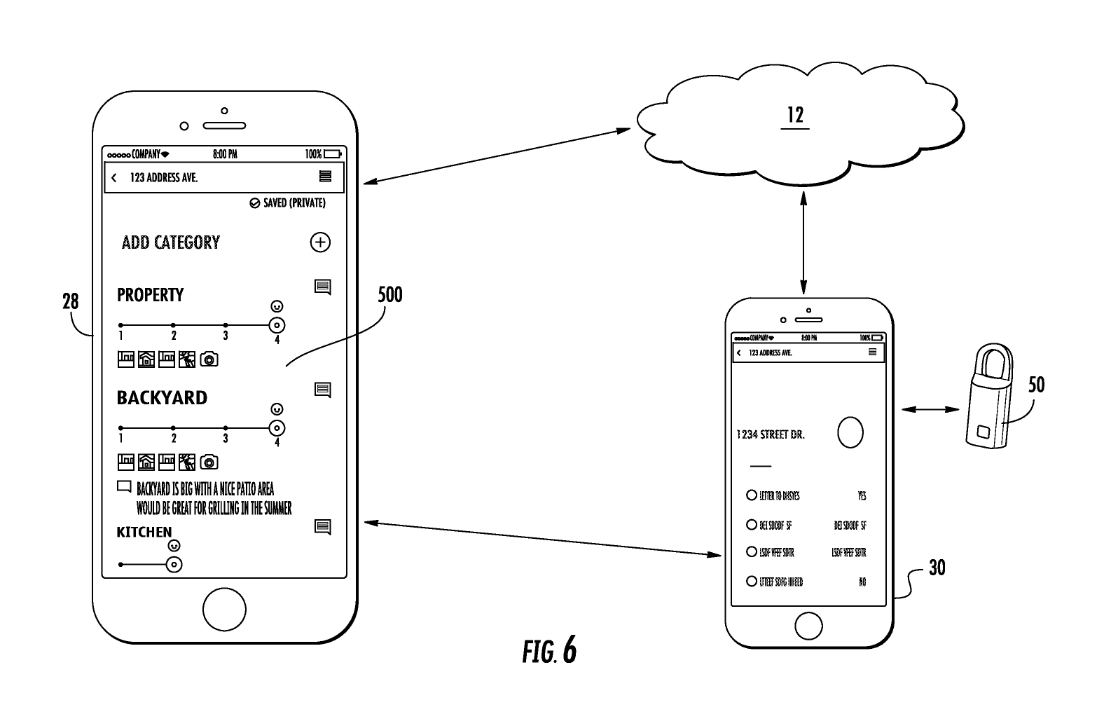

Next, during the showing, feedback is entered into the real estate feedback application 500 by the buyer “B” for the property (216; FIG. 5 and FIG. 6) as further discussed below. The feedback may include any data associated with the properties that may, for example, facilitate reviewing and comparing properties. The real estate feedback application 500 may be a module of the real estate application 38, and/or other application.

In addition to the features discussed above, the buyer “B” can utilize the real estate feedback application 500 to record feedback for each property visited. In one or more embodiments, the buyer “B” can take pictures, videos, and/or notes during the property showing. In one or more embodiments, the feedback may be provided as a scale rating (FIG. 5). For example, the scale rating may be numeric 300 (e.g., 1-10), emoji based 302 (e.g., happy face, sad face), color coded (e.g., red, yellow, green), or other such ranking. Further, the rating may be specific to particular locations of the property, (e.g., backyard, kitchen, etc.) and/or features, (e.g., appliances, fixtures, etc.). In one or more embodiments, the buyer “B” is prompted for feedback. In one or more embodiments, the buyer is prompted for feedback based on the location of the buyer within the property (e.g., via global positioning of the buyer within the property by way of the GPS module 68 (FIG. 2)) such that when the buyer enters, for example, the kitchen, the real estate feedback application 500 prompts the buyer for feedback on the kitchen, etc. In one or more embodiments, the buyer can add a category 304 to provide feedback thereon (e.g., garage).

The feedback is then saved in memory 66 (FIG. 2) via the real estate feedback application 500 so that the buyer can review at a later time (218). The feedback can also be used to compare properties reviewed by the buyer. As the buyer generates feedback about the property, the real estate feedback application 500 may also upload the feedback to the buyer storage system 18 via the buyer API 34 (220; FIG. 1). Once the showing is complete, the buyer “B” can choose to selectively share the feedback with their showing agent “R” via the real estate feedback application 500 which, in response, authorizes the listing recommendation server 14 to release the feedback from the buyer storage system 18. The agent application 40 then syncs with the listing recommendation server 14 and downloads the feedback (222). The showing agent “R” is then able to review the feedback on the agent application 40.

Through the agent application 40, the showing agent “R” can communicate the feedback to the listing agent “L” (224). In one or more embodiments, the feedback may be forwarded through an email app, text messaging app, social media, or other app on the handheld device 30, and need not be through the subsystem 12. For example, an email app resident on the handheld device 30 is called by the agent application 40, and the feedback is automatically copied into the email by the agent application 40. The showing agent “R” may then edit the email prior to sending the feedback to the listing agent “S.”

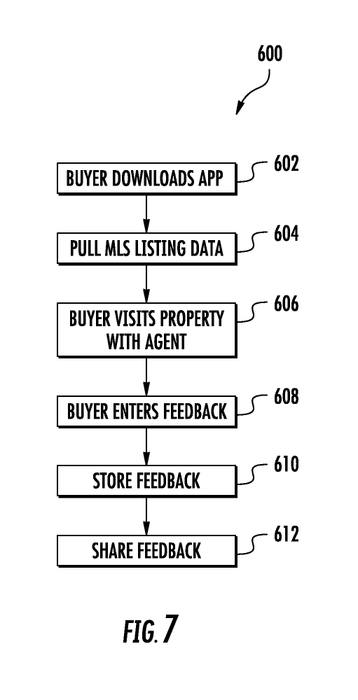

With reference to FIG. 7, a method 600 for providing feedback via the real estate feedback application 500 from the perspective of the buyer “B” is disclosed in terms of functional block diagrams. The functions are programmed software routines and executable instructions capable of execution in various microprocessor based electronics control embodiments and represented herein as block diagrams.

Initially, the buyer “B” may download (602) the real estate feedback application 500 from a source such as an app store. The real estate feedback application 500 communicates (604) with the listing recommendation server 14 via the buyer API 34 to pull the agent selected MLS listings. The showing agent “R” then typically escorts the buyer “B” for a showing of particular properties selected by the buyer (606). Next, during the showing, the buyer “B” enters (608; FIG. 5) the feedback into the real estate feedback application 500. The real estate feedback application 500 then saves the feedback for retrieval at a later time (610). The buyer “B” can then utilize the real estate feedback application 500 to review the feedback and compare notes on the properties.

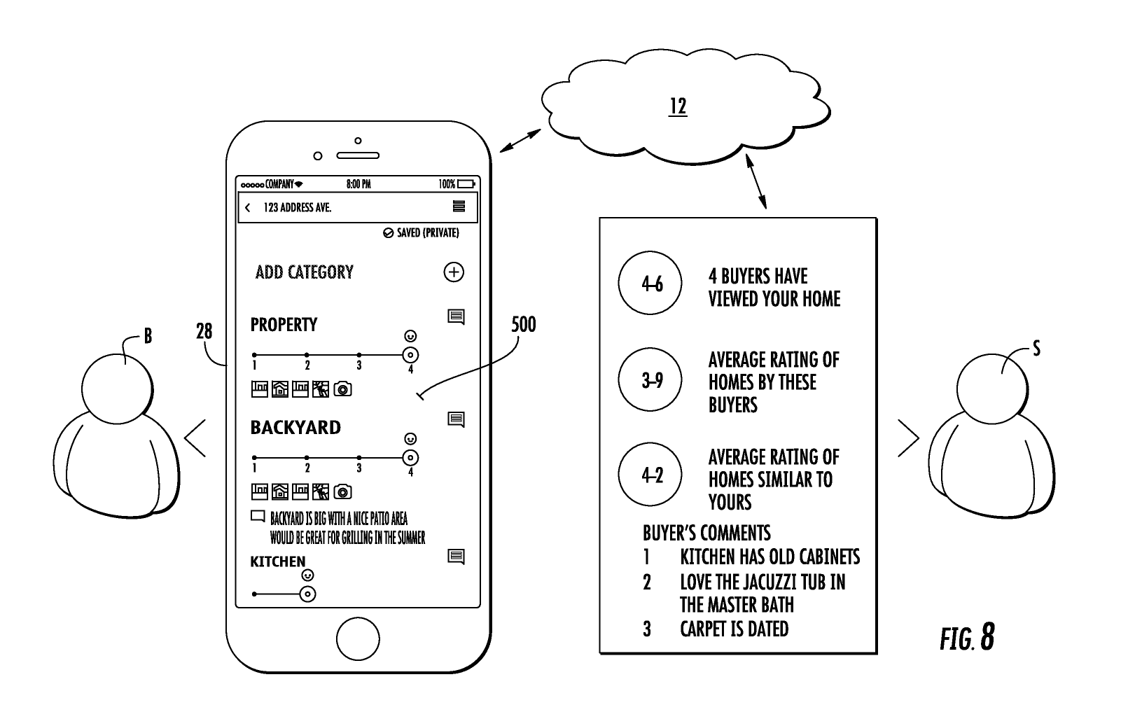

Once the showing is complete, the buyer can choose to share the ratings with their showing agent “R” (612). If they so choose, the real estate feedback application 500 will send a message to the listing recommendation server 14 though the buyer API 20 to release the ratings to the showing agent “R.” The feedback may be provided to the listing agent “L” through the subsystem 12. In this embodiment, the real estate feedback application 500 uploads the feedback data from the buyer database 18 to the electronic key server 22 via the buyer API 34 which then generates a report for the listing agent “L” (FIG. 8). The feedback report may include, but is not limited to, the buyer's feedback on the subject property, the buyer's feedback on the subject property compared to other properties, the buyer's interest in the subject property compared to other buyers' interest in the subject property by other buyers, other properties which may be comparable to the subject property based on the buyer's feedback, etc.

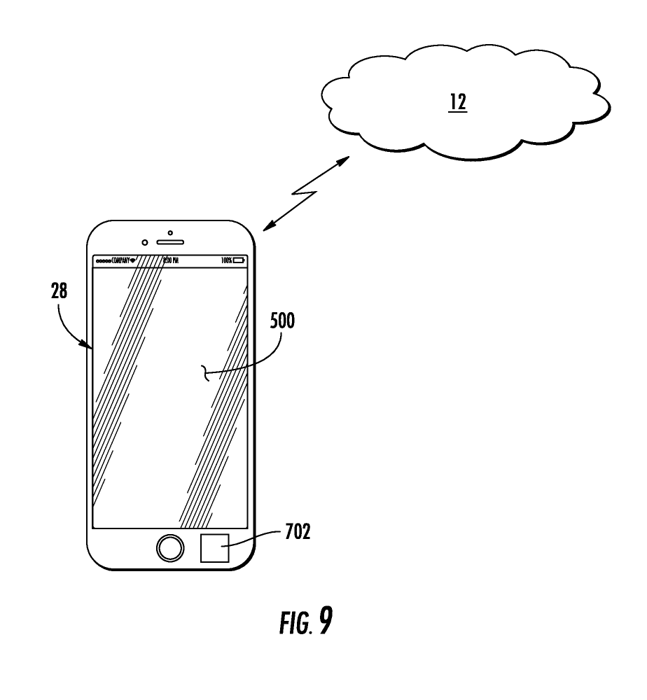

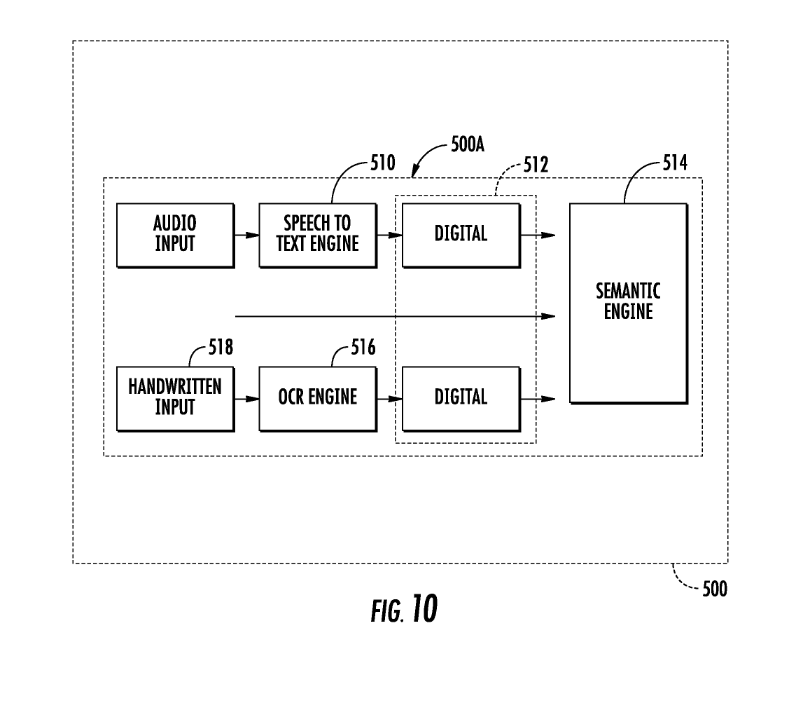

With reference to FIG. 9, a narrative feedback system 700 generally includes a real estate narrative feedback application 500A (FIG. 10) as a module, portion, or feature of the real estate feedback application 500. A microphone 702 receives input to the real estate narrative feedback application 500A. For example, during a property showing, as the buyer “B” walks from room to room, the buyer “B” narrates their feedback about that particular room in real time via voice. The microphone 702 may be within the handheld device 28 such as a tablet, smart phone, or wearable device (e.g., a watch). That is, the microphone 702 is typically already on board the handheld device and need only be activated by the real estate feedback application 500. Alternatively, or in addition, the buyer “B” can input written notes into the real estate narrative feedback application 500A.

With reference to FIG. 10, the real estate narrative feedback application 500A includes a speech to text engine 510, a database 512, and a semantic engine 514. Although the speech to text engine 510, the database 512, and the semantic engine 514 are associated with the real estate narrative feedback application 500A and may all be on board the handheld device 28, one or more modules thereof may be located in the subsystem 12. In one embodiment, the database 512 is proprietary and located in the subsystem 12 that is accessed by through the real estate feedback application 500.

The speech to text engine 510 may include various speech conversion modules. Alternatively, or in addition, an optical character recognition module 516 may utilize text input 518. The text input 518 may be an input into the real estate narrative feedback application 500A or otherwise uploaded thereto.

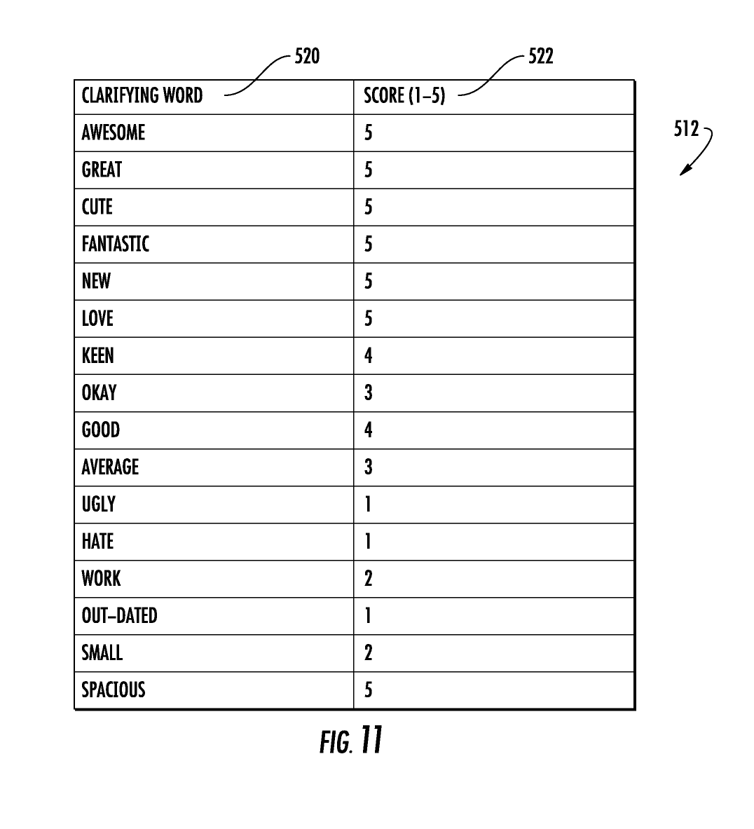

The database 512 stores a multiple of clarifying words 520 (FIG. 11) and an associated value 522 of each of the multiple of the clarifying words. The semantic engine 514 is in communication with the speech to text engine 510 and the database 512 to associate narrative feedback data input into the speech to text engine 510 into a feedback value for a subject property as will be further described below.

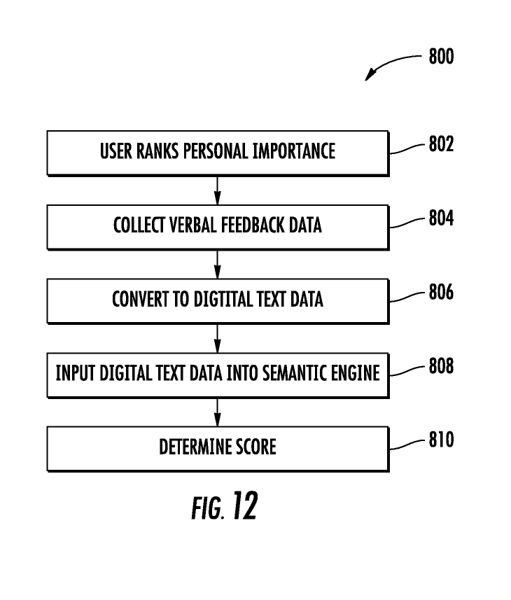

With reference to FIG. 12, a method 800 for verbally determining feedback via the real estate narrative feedback application 500A is disclosed in terms of functional block diagrams. The functions are programmed software routines and executable instructions capable of execution in various microprocessor based electronics control embodiments and represented herein as block diagrams.

Initially, the microphone 702 is likely already a component of the handheld device of the buyer “B” which is in communication with the real estate feedback application 500. Alternatively, another device with a microphone 702 may be made available to the buyer “B” for the duration of the property showing. The showing agent “R” then typically escorts the buyer “B” for a showing of particular properties selected by the buyer.

The real estate feedback application 500 may initially include a ranking (802) which weighs the user preferences. For example, the user may initially identify that the kitchen and bedrooms are of primary importance in the real estate feedback application 500.

Next, narrative feedback data as the buyer “B” tours the property, the narrative feedback data made by the buyer “B,” are collected (804). The narrative feedback data may be communicated and stored in the handheld device memory 66. This narrative feedback data is then converted (806) to digital text data via a voice to text software that is commonly available. Alternately, or in addition, the narrative feedback data is converted via optical character recognition.

Next, the digital text data is input into a semantic engine (808) to determine a score (810) for attributes of the property.

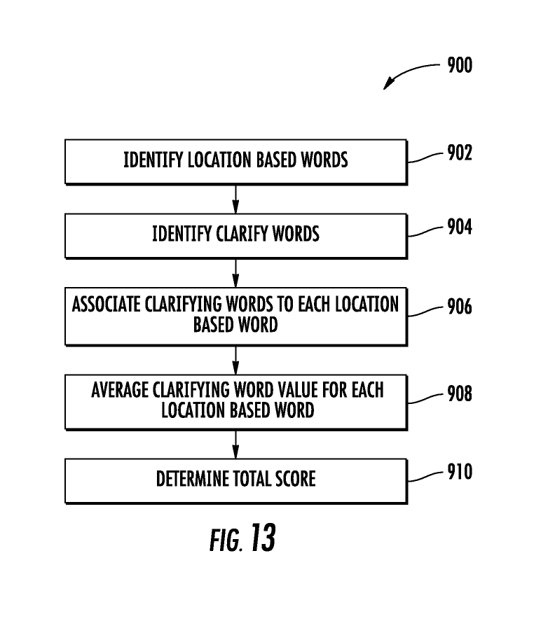

With reference to FIG. 13, a method 900 for determining the score in one embodiment is disclosed in terms of functional block diagrams. The functions are programmed software routines and executable instructions capable of execution in various microprocessor based electronics control embodiments and represented herein as block diagrams.

The score may be initially determined by identification of location based words (902) in the narrative feedback data. That is, the narrative feedback data is scanned for predetermined location based words, for example, exterior yard, kitchen, etc., that are stored in the database 512.

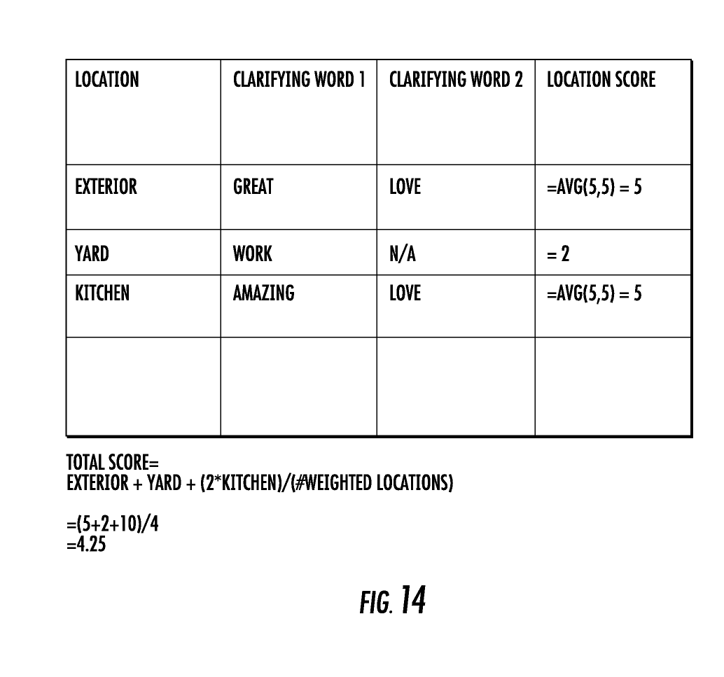

The semantic engine then identifies (904) words (primarily adjectives, FIG. 14) that describe the quality of the associated location based words which are herein defined as clarifying words. The clarifying words are then associated (906) with the location based word. That is, the clarifying words may be adjectives that are within a predetermined search distance (e.g., ten words forward and/or aft) from the location based words in the narrative feedback data. Multiple clarifying words may also be identified within a predetermined distance from the location based word, and/or from a previous clarifying word by the semantic engine 514.

The real estate narrative feedback application 500A utilizes the database 512 of clarifying words and a ranking value therefor (FIG. 11). Generally, positive words (e.g., great, awesome, keen) may have a high-ranking number (e.g., 7-10) neutral words (e.g., nice, decent) may have a neutral ranking number (e.g., 4-6) while negative words (e.g., ugly, outdated, old) have a low-ranking number (e.g., 0-3). The ranking number may be associated with current state of language and reference conventional contemporary usage to modify the scale thereof as some positive, or negative, words fall out of favor over time (e.g., groovy). In one particular embodiment, the scoring may be performed via a Likert scale (1-7). Various scales (e.g., such as 1-100) and weighting factors (multipliers) may alternatively or additionally be provided whereby positive words correspond to higher numbers than negative words. The particular table of clarifying words and a ranking value therefor may be proprietary and stored in the subsystem 12.

Next, for each location based word, the clarifying word value may be averaged (908). The number of clarifying words may also facilitate weighting of the average as a user may typically be more expressive for those locations the user particularly likes or dislikes.

Finally, a total score is determined (910) for the property. The total score may be based on an average, an algorithm, and/or other relationship. For example:

Total score=exterior+yard+(2*kitchen)/(# weighted locations).

One or more particular locations (e.g., the kitchen) may be more heavily weighted (e.g., ×2) based upon the user preference (FIG. 12; 802) previously input into the real estate feedback application 500.

Decisions are often based on both logic and emotion. By capturing the verbal response of the buyer “B” during the property showing in real time, both logical and emotional views on the subject property that a user may “blurt out” are readily captured. Additionally, the narrative feedback system requires essentially no effort by the user.

The elements described and depicted herein, including in flow charts and block diagrams throughout the figures imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason, the appended claims should be studied to determine true scope and content.

What is claimed:

1. A method for processing feedback for a real estate property, comprising:
receiving narrative feedback data for a subject real estate property; and
converting the narrative feedback data for the subject real estate property to a value in response to at least one location word and at least one clarifying word proximate to the location word.

2. The method as recited in claim 1, wherein the receiving the narrative feedback data is performed with a microphone of a handheld device.

3. The method as recited in claim 1, wherein the converting the narrative feedback data for the subject real estate property is performed with a subsystem with which a real estate feedback application on a handheld device is in communication.

4. The method as recited in claim 1, wherein the converting the narrative feedback data for the subject real estate property is individually performed for each of a multiple of locations in the subject real estate property via a database that stores a multiple of the clarifying words and an associated value of each of the multiple of clarifying words.

5. The method as recited in claim 4, further comprising averaging the value for each of the multiple of locations to determine a total score for the subject real estate property.

6. The method as recited in claim 4, further comprising weighting the value for each of the multiple of locations of the subject real estate property.

7. The method as recited in claim 6, further comprising weighting the value for at least one of the multiple of locations of the subject real estate property to determine a total score for the subject real estate property.

8. The method as recited in claim 1, further comprising weighting the value for at least one of the multiple of locations of the subject real estate property in response to a user input to a handheld device operating a real estate feedback application.

9. The method as recited in claim 1, wherein the receiving the narrative feedback data is performed with a text input to a handheld device operating a real estate feedback application.

10. The method as recited in claim 1, wherein the converting the narrative feedback data comprises scanning the narrative feedback data for the at least one location word from a database via a semantic engine.

11. The method as recited in claim 10, wherein the converting the narrative feedback data comprises scanning the narrative feedback data for the at least one clarifying word from the database via the semantic engine.

12. The method as recited in claim 11, wherein the converting the narrative feedback data comprises associating the clarifying word with the location word based on a predetermined distance.

13. The method as recited in claim 12, wherein the predetermined distance is a predetermined number of words.

14. The method as recited in claim 11, wherein the converting the narrative feedback data comprises associating the clarifying word with a ranking value in a database from external a handheld device prior to the converting, the handheld device accessing the ranking value during the converting.

15. The method as recited in claim 14, wherein the ranking value is a numerical value.

16. The method as recited in claim 14, wherein the ranking value is associated with a Likert scale.

17. A real estate narrative feedback application, comprising:
a speech to text engine to receive narrative feedback data for a subject real estate property;
a database of a multiple of clarifying words and an associated value of each of the multiple of clarifying words; and
a semantic engine in communication with the speech to text engine and the database to convert the narrative feedback data into a value for the subject real estate property.

18. The application as recited in claim 17, wherein at least one of the speech to text engine, the database, and the semantic engine, run on a handheld device.

19. The application as recited in claim 18, further comprising determining a total score for the subject real estate property.

20. The application as recited in claim 17, wherein the associated value of each of the multiple of clarifying words is associated with a Likert scale.
